(19) United States
(12) Patent Application Publication
(10) Pub. No.: US 2015/0331160 A1
(43) Pub. Date: Nov. 19, 2015

(54) SECURITY DEVICE

(71) Applicant: SECTAGO GMBH, Saarbruecken (DE)

(72) Inventors: Peter ROGIN, Saarbrucken (DE); Markus KOCH, Pirmasens (DE); Frank SEILS, Kleines Wiesental (DE)

(21) Appl. No.: 14/443,069

(22) PCT Filed: Dec. 2, 2013
(86) PCT No.: PCT/EP2013/075244

§ 371 Date: May 14, 2015

(30) Foreign Application Priority Data
Dec. 4, 2012 (EP) 12195437.4

(51) Int. Cl. G02B 5/18

(52) U.S. Cl. CPC G02B 5/18

(57) ABSTRACT

A security device for improving the security against falsification of articles has a carrier element. Arranged on the upper side of the carrier element are a large number of diffractive surface elements. The surface elements respectively form a number of surface element groups, surface structures of which are made to match one another in such a way that they show a point of the symbol to be represented over an entire observation sphere. By changing the angle of incidence of the light and/or the angle of observation of an observer, a continuous movement of the symbol in the observation sphere is perceived by the observer.

The invention concerns a security device for improving security against forgery of articles worth protecting, in particular original articles like for example products, marks, entry cards and documents, in particular high-security documents like for example personal documents and payment means.

A large number of security devices are provided in relation to high-security documents, in particular personal documents like passports, personal identity cards, driving licences and the like as well as payment means like credit cards, banknotes and the like. This involves for example the provision of security devices which are visible to the human eye like holograms. In addition there are provided security devices which are not visible to the human eye or which are visible only under special light and which are produced for example by colour pigments introduced into the high-security document.

WO 2010/115936 discloses a security device which is particularly suitable for payment means. It has a reflection layer like an aluminium film, on the top side of which is arranged a plurality of diffractive surface elements. The individual surface elements have a sinusoidal surface structure for producing a diffraction grating. In that case the individual surface elements are such that incident light is diffracted in such a way that the observer is given an impression similar to the natural asterism. An observer therefore recognises for example a star-shaped symbol which rotates about itself in an image plane.

In spite of the already existing large number of security devices there is still a need for the development of a security device which is as forgery-resistant as possible and which can be detected by machine or also by the naked eye.

The object of the invention is to provide such a security device.

According to the invention the object of the invention is attained by a security device for improving the security against forgery of articles in accordance with claim 1.

According to an aspect of the invention the security device has a plurality of diffractive surface elements on a carrier element. The individual surface elements can have different base surfaces like circles, polygons and so forth or combinations. Provided at the top side at which light is diffracted is a surface structure. The surface structure is in particular a diffraction grating of any surface profile, for example sinusoidal, rectangular or triangular. Those diffraction gratings can be transparent on a transparent or reflecting carrier element or they can also themselves be reflecting.

In an aspect of the invention a respective plurality of surface elements which are preferably arranged distributed over the entire surface form a surface element group. The surface structures of the individual surface elements of such a group are matched to each other in such a way that light incident at a defined angle is focused at a point. In that case matching of the individual surface elements can be implemented both in their surface structure and also in their orientation. By virtue of such a configuration of a surface element group the point can be represented in an observation space. The observation space in a preferred configuration can be an observation sphere, in which respect it is further advantageous if the point is represented in the entire observation space or the entire observation sphere. The invention is described hereinafter by means of the embodiment of the observation space in the form of an observation sphere.

The representation of a point is effected for example upon a change in the light/incidence angle and/or an observation angle of an observer in the observation sphere by virtue of the same surface element group. Here in an advantageous embodiment of the invention a change in the angle of incidence of the light and/or the observation angle of the observer provides a movement of the point in the observation sphere, for the observer. The observer perceives a corresponding movement. In particular if the change in the angle of incidence of the light and/or the observation angle of the observer is a uniform change that produces a continuous movement of the point for the observer.

To represent a symbol at least two and in particular a plurality of points can be used. In that aspect of the invention therefore there can be provided a plurality of surface element groups, wherein a point of the symbol is represented by each surface element group. The represented symbol can be any symbol, in particular a geometrical symbol like a circle, a smiley or also individual letters or digits but also a complex logo and a combination of such symbols.

Now an observer sees only the light which is deflected in his direction. Thus, out of the large number of surface elements of a group, the only ones that are visible to him are those which result along his viewing direction from the projection of the focal point in the image plane into the surface of the security device. The totality of the surface elements from all those groups, that are visible from the respective viewing direction, accordingly corresponds to the projection of the entire symbol into that surface. As the projection direction corresponds to the viewing direction the position of the visible symbol changes with the position of the observer relative to the security device. Both upon a change in the angle of incidence of the light and also upon a change in the observation angle of the observer therefore a movement of the symbol is perceived by the observer. That occurs even when the carrier element is moved in space as that corresponds to a combination of the change in the angle of incidence of the light and the observation angle.

In particular the change in the angle of incidence of the light and/or the observation angle of the observer means that fewer and/or other additional surface elements of the same group are visible to the observer. Thus the point in the observation sphere upon a change in the angle of incidence of the light and/or the observation angle of the observer is represented by fewer and/or other additional surface elements of the same group. In that way an observer perceives a movement of the one point in the observation space. This does not involve an apparent movement, produced by the superimpositioning of a plurality of similar but not exactly identical images. Rather, an image which is variable in location of one and the same represented point is produced by a group of surface elements. In that case the symbol in itself is invariable as the sum of all represented points, and therefore cannot be modified. Only the position of the symbol within the observation space is altered by the change in the angle of incidence of the light and/or the observation angle of the observer. In that respect, upon a change in the angle of incidence of the light and/or the observation angle of fewer surface elements, the same surface elements, in particular upon a small change in the angle of incidence of the light and/or the observation angle, further surface elements or in part or completely other surface elements of the same group are visible for the observer.

In regard to that observer the symbol advantageously moves along a path. That path in a particularly advantageous embodiment is curved.

Due to an advantageous uniform distribution of the surface elements of each group over the entire surface of the safety device, that provides that the symbol remains visible from every viewing direction within a wide range of viewing angles and moves in particular continuously upon an in particular uniform change in the viewing angle within that range.

If the angle of incidence of the light changes then the position of the focal point produced by the surface elements of a group also changes and therewith also the position of the represented symbol. That also gives the observer the impression of a continuous movement in particular in the case of a uniform change in the angle of incidence of the light. The perceived movement occurs as the sum of the influences of changes in the angle of incidence of the light and the observation angle.

In addition the above-mentioned influences also apply in combination with each other, like for example upon rotation and/or tilting of the carrier element. With the above-mentioned movements of the symbols that gives the impression of a rotation of the symbols about a virtual point or a translation movement along a line.

The use of diffraction gratings means that in the general case a plurality of diffraction orders occur, the intensity ratio of which is determined by the detailed configuration of the surface structure. The various diffraction orders focus the incident light in different image planes so that a plurality of varieties of the represented symbol become visible, with respectively different movement patterns. A preferred embodiment exhibits a strong emphasis on a variety in relation to all others. That can be achieved for example by suitable asymmetry of the grating structure.

In another advantageous embodiment substantially two equally bright varieties of the symbol are shown, with opposite movement patterns. They increasingly approach each other in proportion to the reduction in the deflection angle. In that respect the deflection angle is the deviation between the direction of the observer and the direction along which the light would be propagated in the case of direct transmission or reflection (depending on the respective configuration of the element). That can be achieved for example by the suppression of higher diffraction orders, for example by adaptation of the grating profile.

In a further aspect of the invention the displayed symbol is visible within a wide range of viewing angles, of in particular more than 60° and particularly advantageously more than 90°. That defines the observation sphere. That requires a wide range of variations in the configuration of the surface structures, in particular the orientation of the surface structures can assume any desired angle in the carrier element surface. A wide variation in the grating constant is equally necessary, in particular for that purpose the simultaneous use of very small and large grating constants is required.

Advantageously the range of the simultaneously used grating constants is between ≦500 nm (≧2000 lines/mm) and ≧1500 nm (≦666 lines/mm), particularly advantageously between ≦300 nm (≧3333 lines/mm) and ≧500 nm (≦200 lines/mm). It is advantageous for the size relationship of the largest to the smallest grating constants at the surface structures to be in a ratio of at least 3:1 and particularly advantageously at least 10:1.

It is further advantageous for the surface elements to be such that the symbol is respectively produced by less than 10%, in particular less than 5%, of the surface elements provided on the carrier element.

Advantageously the surface structured on the carrier element is covered with surface elements to at least 10%, in particular at least 30% and particularly advantageously at least 50%. By virtue of such filling factors in respect of the surface with surface elements it is possible to produce a clearly visible symbol with adequate brightness so that the symbol can be perceived by the human eye unaided.

The security device according to aspects of the invention can be transparent, reflective or also semi-reflective, that is to say semi-transparent for light. The transparent implementation is used in particular when security checking of the article to be protected is to be effected by means of transmissive visual inspection and the article itself is at least partially transparent.

One or more sides of the security device according to aspects of the invention can be such that they reflect light impinging thereon. For that purpose for example the carrier element at an underside and/or a top side and/or the surface elements can have a light-reflecting layer. For example this can respectively involve a layer comprising a metal like for example aluminium, silver, copper, gold or chromium. Obviously metal alloys and/or combinations of different metals are also suitable. The provision of an aluminium layer is particularly suitable. In particular in a configuration with light-reflecting layers at at least two sides it is advantageous for at least one of those layers to be semi-transparent. The provision of reflecting layers is dependent in particular on the situation of use of the security device. Thus reflection layers for the security device are required in particular when security checking of the article to be protected is to be effected by means of visual inspection by looking at it and incident light is not reflected or is inadequately reflected by that article.

To produce the surface elements it is possible to apply a lacquer to the carrier element and to produce the individual surface elements, in particular the surface structure of the surface elements, by way of a shaping element. Hardening of the lacquer is then effected, advantageously by means of UV light and/or heat. After the operation of shaping the surface elements the lacquer layer is advantageously of a thickness of 0.5 to 300 μm, particularly advantageously from 0.8 to 50 μm and in particular from 1 to 10 μm. Advantageously the carrier material and/or the surface elements have a polymer material or is made from polymer.

Production of the surface elements can be effected in such a way that the carrier element comprises a thermoplastic material or has thermoplastic material and structuring of the individual surface elements is transferred from a shaping element on to the thermoplastic material. In particular that can be effected by means of embossing methods.

To produce the diffractive surface elements constituting the security device firstly information is generated in particular by means of data processing programs relating to the configuration of three-dimensional surface structures on a plurality of surface elements. That is effected by a procedure whereby, as described hereinbefore with reference to the security device, surface element groups comprising a plurality of surface elements are formed and the surface structures and the orientation of the surface element groups are matched to each other in such a way that the surface element groups form a point of the symbol to be represented, in an observation space. In addition information is further generated, by which a plurality of surface element groups are so adapted that they respectively produce an image of a point so that the symbol to be represented is made up of the sum of all points represented by the surface element groups. The plurality of diffractive surface elements with three-dimensional surface structures are now arranged on a carrier element on the basis of the generated information to produce the security device.

It is particularly advantageous for the security device according to the invention to be provided on or in payment means like banknotes and the like. Other high-security documents like credit cards, passports, personal ID, driving licences, social security cards and so forth can also be provided with the security device according to aspects of the invention for simple checking as to whether an original article or a forgery is involved.

That has in particular the advantage that it is visible by an observer without the assistance of particular reading device or other aids.

The provision of a security device according to aspects of the invention is also advantageous on documents like share certificates, tax seals, entry cards, permits and so forth. That applies in particular also for products and brands like drugs, spirits, tobacco goods, spare parts, luxury goods and so forth.

In addition a combination with one or more further security features is possible, for example with a hologram and/or machine-readable security features.

The invention will be described in greater detail hereinafter by means of a preferred embodiment with reference to the accompanying drawings in which:

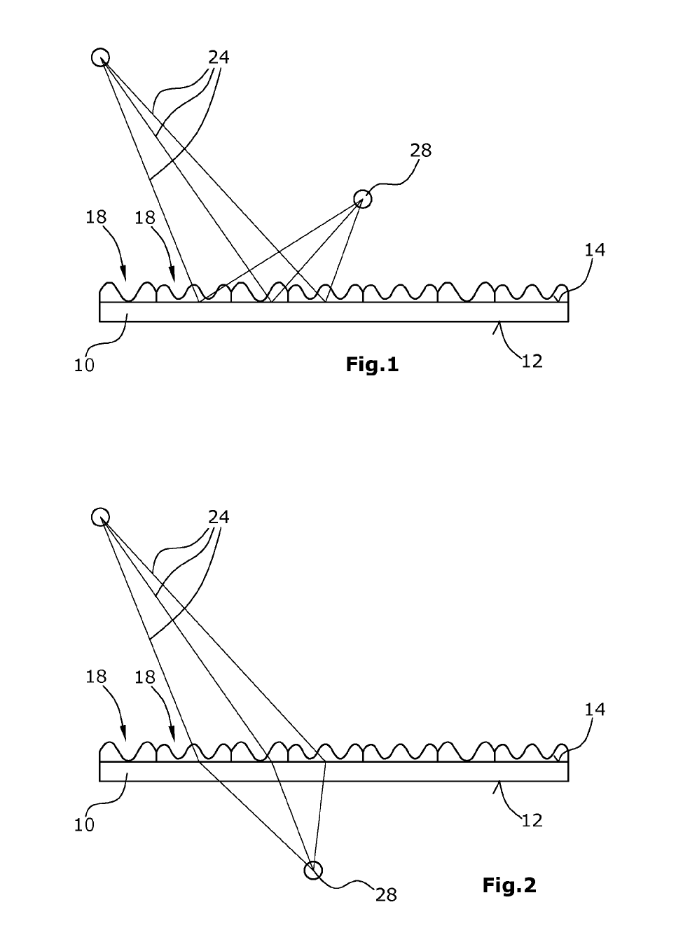

FIG. 1 shows a diagrammatic side view of a portion of an embodiment of a security device according to the invention,

FIG. 2 shows a diagrammatic side view of a portion of a further embodiment of a security device according to the invention,

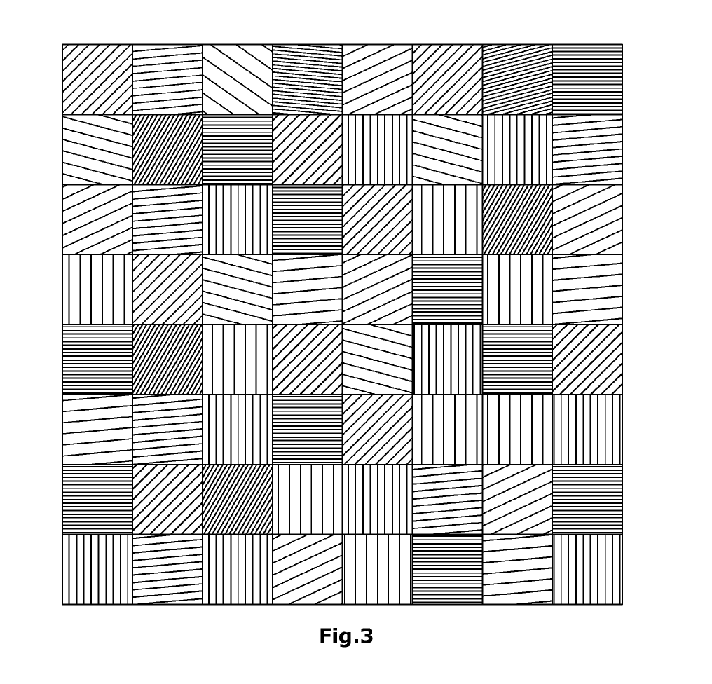

FIG. 3 shows a diagrammatic plan view showing the principle of the security device according to the invention,

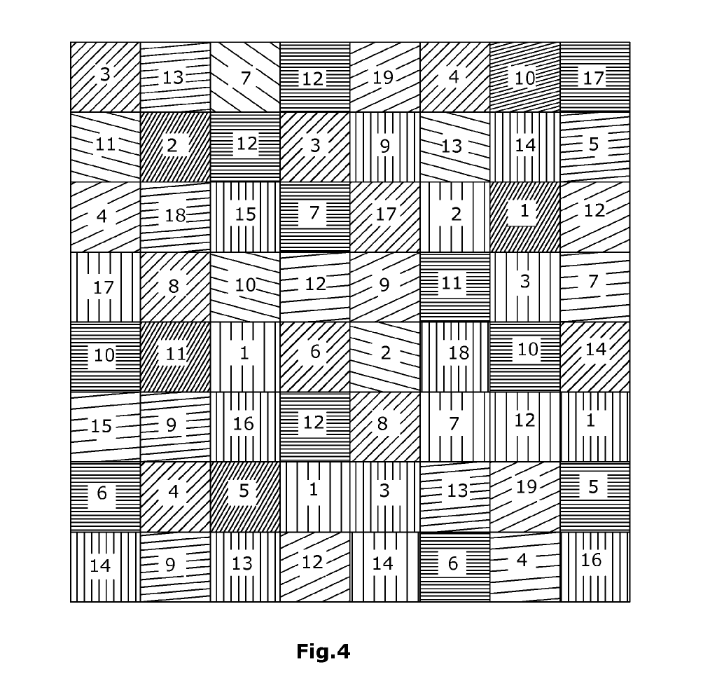

FIG. 4 shows a diagrammatic plan view showing the principle of a security device according to the invention, wherein surface element groups are identified by numbers for clear identification purposes,

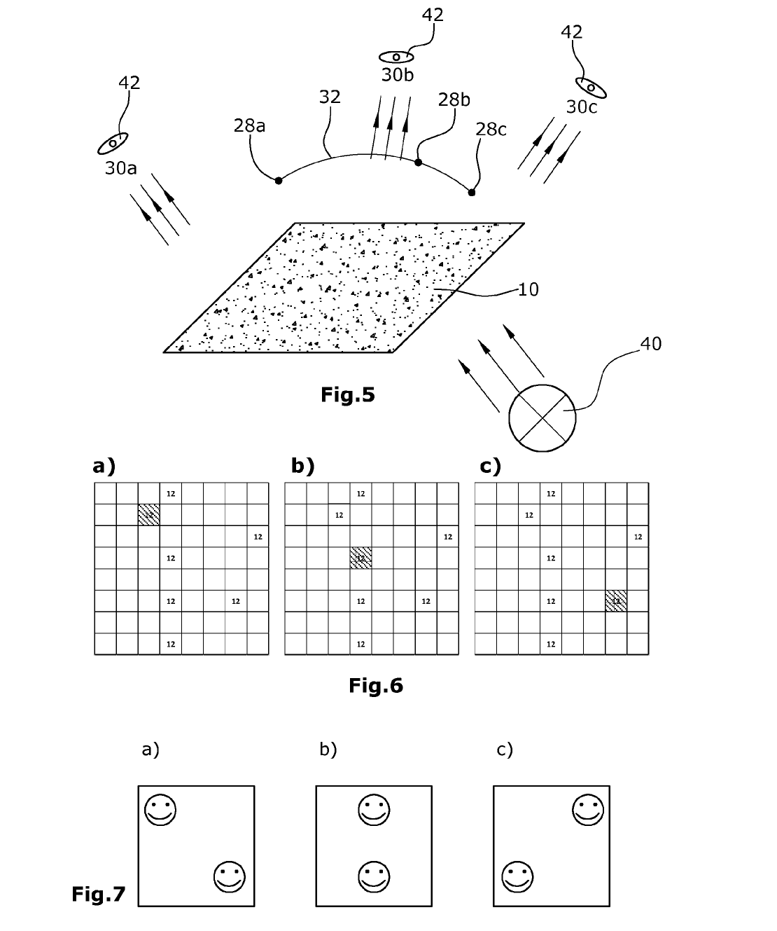

FIG. 5 shows a diagrammatic perspective view showing the principle of a security device according to the invention,

FIG. 6 shows a diagrammatic view of the visible surface elements of a selected group, and

FIG. 7 shows a diagrammatic view of the symbols perceived by the observer at different angles.

In the first illustrated embodiment (FIG. 1) the security device according to the invention has a light reflection element 10 which is for example a metal film or a carrier element of for example polymer, paper or the like with an applied metal layer, for example of vapour-deposited aluminium. The light reflection element 10 is arranged for example with an underside 12 on a product to be secured like a credit card, a banknote or the like. If the product to be secured is entirely or partially transparent a further configuration of the light reflection element 10 is for example such that it is arranged with a top side 14 towards the product side. A multiplicity of diffractive surface elements 18 are arranged at a surface 14 of the light reflection element. The individual surface elements 18 are in the form of diffraction gratings. The individual surface elements can be produced for example in one process step by a lacquer being applied to the surface 14 of a carrier element 10 and structured by way of a shaping element. That advantageously involves using a lacquer which can be hardened by UV radiation or the effect of heat. In that case, after shaping of the surface elements 18, the hardened lacquer layer is advantageously of a thickness of 0.8 to 50 μm. In addition the individual surface elements can be produced for example in one process step by the light reflection element 10 comprising a thermoplastic carrier element into which the surface elements 18 are structured directly for example by means of embossing methods, using a shaping element. In the last-mentioned case, unlike that diagrammatically shown in FIG. 1, there would not necessarily be an interface 14 between the light reflection element 10 and the surface elements 18.

Incident light beams 24 are reflected at the surface 14 of the light reflection element 10, after diffraction possibly already occurred upon passing into the lacquer layer or the thermoplastic carrier element. On issuing from the surface elements the light beams are diffracted by the diffraction grating provided at the outside surface of the individual ones, in such a way that they meet at a common point 28. The beams shown as lines are illustrated in simplified form so that only the reflection at the surface 14 and not the diffraction occurring in or at the surface elements 18 is shown.

As described hereinafter in particular with reference to FIGS. 3 and 4 a point 28 is represented by a group of a plurality of individual surface elements 18. The representation of the point 28 which moves in space is always effected by the same surface element group on the basis of the change in the angle of incidence of the light and/or the observation angle. Thus the representation of a symbol is effected by representation of a plurality of points so that a plurality of surface element groups are arranged on the carrier element 10, in a manner corresponding to the number of points that are to be represented of the symbol.

Instead of the provision of a reflective security device it can also be of a transparent nature by means of a transparent carrier element (FIG. 2). The beams 24 thus pass through the surface elements 18 and the carrier element 10, in which case, as described with reference to FIG. 1, a point 28 is represented in space by the group of surface elements 18.

The individual surface elements 18 have diffraction gratings, these being only diagrammatically shown in FIGS. 1 and 2.

In this embodiment of the invention the security device has a multiplicity of surface elements 18 on a reflecting or transparent carrier element. The individual surface element groups are composed of a plurality of surface elements 18 which are irregularly distributed on the carrier element. FIGS. 3 and 4 show the composition of the surface element group as an example. FIG. 3 shows an example of a diagrammatic plan view of a multiplicity of surface elements shown as squares, in which different grating structures are diagrammatically illustrated by lines. The individual surface elements have grating structures with grating constants in the range of ≦500 nm to ≧1500 nm, particularly preferably from ≦300 nm to ≧5000 nm. In FIG. 3 some surface elements have identical structures. FIG. 4 then shows an example where surface elements 18 are combined to form surface element groups. Individual groups are identified by the numerals 1, 2, 3 . . . for illustration purposes. In this case a surface element 18 is arranged in each square denoted by a number. The individual surface elements 18 of a surface element group have in particular surface elements 18 with different surface structures (FIG. 3). The surface structure varies in particular in its orientation or direction. In addition the surface structure varies in the height or amplitude of the individual gratings and the period thereof.

FIG. 5 shows in principle a configuration of a security device according to the invention. The carrier element 10 is provided with a multiplicity of individual surface elements 18 which are represented as points of differing configurations. Individual ones of the surface elements illustrated here are respectively combined together to form groups, as is apparent for example from FIG. 4. Light is projected from a light source 40 on to a rear side of the carrier element 10 which is transparent in this embodiment. To check the security element or to detect a movement of the symbol in this embodiment an observer 42 moves from a position 30a to a position 30b and from that to a position 30c. The number and arrangement of the surface elements is so selected that, as illustrated by the line 32, upon a continuous change in the observation angle, the symbol composed of points 28 continuously moves. For the observer, that movement occurs in the observation sphere defined in FIG. 5 above the carrier element. In that situation the observation angle changes in the illustrated embodiment from the observation angle 30a by way of the observation angle 30b to the observation angle 30c. A corresponding consideration applies to the situations where the angle of incidence of the light continuously changes or the angle of incidence of the light and the observation angle continuously change at the same time. A simultaneous change in the angle of incidence of the light and the observation angle is effected for example when the security element or the carrier element 10 is moved.

FIG. 6 shows by way of example a diagrammatic view of an individual group of surface elements 18 on the security element. Based on FIG. 4 for that purpose by way of example the group ‘12’ comprising seven surface elements was selected. In this case the surface elements are still preferably arranged irregularly on the surface element 10 and can also all exchange position with adaptation of the respective parameters (grating period and grating vector) with other surface elements, in particular also belonging to other groups, on the carrier element 10. For representation purposes the surface elements are disposed in a matrix form, wherein the same surface elements are represented in the three respective matrices shown. The three matrices show the action of a change in the position of an observer, for example corresponding to the observation positions 30a, 30b and 30c in FIG. 5, wherein the surface elements which are visible to the observer at the respective observation angle are shown hatched. A partial amount of all the surface elements of a group always makes a contribution to the point 28 being represented. Thus, at a given observation angle, not all observation elements of a given group contribute to the representation of a point. If the position of the observer and thus the observation angle alters the surface elements contributing to the representation change. In that case however the represented point 28 is still represented by surface elements of the same group. Upon a variation in the observation angle therefore the point 28 is represented by in part different or completely different surface elements of the same surface element group.

FIG. 7 shows a simplified view of how a symbol can move for a viewer. At an observation angle 30a the viewer sees two symbols which are here represented as smileys. In this case for example the symbol in the top left corner is produced by the +1st order diffraction and the symbol in the bottom right corner is produced by the −1st order. When the observer moves to the position 30b (FIG. 5) the symbol moves from the top left corner towards the right into the centre and the symbol moves from the bottom right corner towards the left into the centre. In the position 30c the upper symbol moves further towards the right into the top right corner and the lower symbol moves further towards the left into the left corner. The observer thus sees a continuous movement of the two symbols.

1. A security device for improving the security against forgery of original articles by the provision of a symbol comprising
a plurality of diffractive surface elements (18) arranged on a carrier element (10),
wherein each individual surface element (18) has a three-dimensional surface structure,
wherein a plurality of surface elements (18) form a surface element group whose surface structures and orientation are so matched to each other that in an observation space they form the image of a point of the symbol (28) to be represented,
wherein there are provided a plurality of surface element groups which respectively form the image of a point, and
wherein the symbol (28) to be represented is composed of the sum of all points represented by the surface element groups.

2. A security device according to claim 1 characterised in that by virtue of the uniform change in the angle of incidence of the light and/or the observation angle a movement of the symbol which is continuous for the observer is perceived in the observation space.

3. A security device according to claim 2 characterised in that upon a constant change in the angle of incidence of the light and/or the observation angle the symbol moves on an in particular curved path (32).

4. A security device according to claim 1 characterised in that only those surface elements (18) are visible which are produced along a viewing direction of the observer from the projection of the focal point in the image plane into the surface of the security device.

5. A security device according to claim 1 characterised in that by virtue of the change in the angle of incidence of the light and/or the observation angle for the observer fewer and/or other additional surface elements (18) of the same group become visible.

6. A security device according to claim 1 characterised in that the surface elements (18) are arranged irregularly on the carrier element (10).

7. A security device according to claim 1 characterised in that the surface elements (18) are of such a configuration and/or arrangement that the visible symbol (28) is produced by fewer than 10%, in particular by fewer than 5%.

8. A security device according to claim 1 characterised in that a surface of the carrier element (10) is covered with surface elements (18) to at least 10%, in particular at least 30% and particularly preferably at least 50%.

9. A security device according to claim 1 characterised in that the surface elements (18) are applied to a carrier element (10) by a procedure whereby a lacquer is applied to the surface (14) of a carrier element (10), the surface elements (18) are structured by way of a shaping element and are thereafter hardened.

10. A security device according to claim 9 characterised in that after the operation of shaping the surface elements (18) the hardened lacquer layer is of a thickness of 0.5 to 300 μm.

11. A security device according to claim 1 characterised in that the carrier element (10) comprises a thermoplastic material and/or has thermoplastic material into which the surface elements (18) are structured by means of a shaping element, preferably by means of embossing methods.

12. A security device according to claim 1 characterised in that it has at least one light-reflecting layer, wherein a light-reflecting layer is preferably applied to the surface elements (18) or the underside (12) of the carrier element (10), the light-reflecting layer preferably having a metal, preferably aluminium, silver, copper, gold or chromium.

13. A security device according to claim 1 characterised in that multiple imaging of the symbol (28) is effected in such a way that a selection of images of the symbol (28) is visible for an observer.

14. A security device according to claim 13 characterised in that in the case of a plurality of visible images of the symbol (28) a selection of images are particularly emphasised in respect of their light intensity, in particular are emphasised in such a way that a perspective effect is visible to the observer.

15. A security device according to claim 1 characterised in that in the case of a plurality of visible images of the symbol (28) only one image is particularly emphasised in respect of its light intensity.

16. A security device according to claim 1 characterised in that the surface structure of the individual surface elements (18) is in the form of a diffractive element.

17. A security device according to claim 1 characterised in that the simultaneously applied grating constants of the surface structures are preferably between <500 nm and >1500 nm.

18. A security device according to claim 1 characterised in that the size relationship of the largest to the smallest of the simultaneously applied grating constants of the surface structures is at least 3:1.

19. A security device according to one of claim 1 characterised in that the surface elements (18) and/or the carrier element (10) contain coloured, luminescent and/or phosphorescent pigments and/or are adapted to be machine-readable.

20. A security device according to claim 1 characterised in that it is combined with other security features, selected from the group including diffractive, refractive, reflective, coloured, luminescent and/or phosphorescent features.

21. A security device according to claim 20 characterised in that other diffractive features are produced by means of a common shaping element.

22. A value document (or security document), in particular a banknote, having a security device according to claim 1.

23. A process for the production of a security device by the provision of a symbol comprising the steps:
generating digital information relating to the configuration of three-dimensional surface structures on a plurality of surface elements (18) by forming surface element groups comprising a plurality of surface elements (18),
mutually matching the surface structures and orientation of the surface element groups in such a way that in an observation sphere they form the image of a point of the symbol (28) to be represented, and
setting up a plurality of surface element groups in such a way that they respectively form the image of a point so that the symbol (28) to be represented is composed of the sum of all points represented by the surface element groups, and
arranging the plurality of diffractive surface elements (18) with three-dimensional surface structures on a carrier element (10).

24. A process for the production of a value document or security document including: producing a security device according to claim 23 and arranging the security device on the value document or security document.
